(19) United States
(12) Patent Application Publication
(10) Pub. No.: US 2024/0181344 A1
(43) Pub. Date: Jun. 6, 2024

(54) COMPUTER-READABLE NON-TRANSITORY STORAGE MEDIUM HAVING SOUND PROCESSING PROGRAM STORED THEREIN, INFORMATION PROCESSING SYSTEM, INFORMATION PROCESSING APPARATUS, AND SOUND PROCESSING METHOD

(71) Applicant: NINTENDO CO., LTD., Kyoto (JP)

(72) Inventor: Jyunya OSADA, Kyoto (JP)

(21) Appl. No.: 18/465,667

(22) Filed: Sep. 12, 2023

(30) Foreign Application Priority Data
Dec. 1, 2022 (JP) 2022-192763

(51) Int. Cl. A63F 13/525; A63F 13/54; H04S 7/00

(52) U.S. Cl. CPC A63F 13/525; A63F 13/54; H04S 7/303; H04S 2400/11; H04S 2400/13; H04S 2400/15

(57) ABSTRACT

A look-at-point position and a viewing direction are determined on the basis of an operation input, and the position of a virtual camera is determined on the basis of the look-at-point position and the viewing direction. In addition, the position of a virtual microphone is interlocked with the virtual camera. For each sound source in a virtual space, the volume of a sound set for the sound source is determined on the basis of the distance between the sound source and a volume reference position set at the position of the virtual microphone or a volume reference position set at a position shifted toward the look-at point side from the position of the virtual microphone in a case where the sound source is placed on the side opposite to the look-at point with respect to the virtual microphone.

### CROSS REFERENCE TO RELATED APPLICATION

This application claims priority to Japanese Patent Application No. 2022-192763 filed on Dec. 1, 2022, the entire contents of which are incorporated herein by reference.

### FIELD

The present disclosure relates to sound control processing for outputting a sound to a speaker.

### BACKGROUND AND SUMMARY

Conventionally, there has been known a third-person-view game in which control is performed with the look-at point of a virtual camera set at the position of a player character.

In such a game, the volume of a sound emitted from a virtual sound source in a virtual space is determined on the basis of the distance between a virtual microphone and the virtual sound source.

Here, a scene in which the virtual camera and the virtual microphone move in an interlocked manner is assumed in the third-person view game as described above. For example, it is assumed that the virtual camera and the virtual microphone move on a circumference centered at the player character corresponding to the look-at point while the viewing direction is directed to the player character. Then, during the movement, it is assumed that a situation in which a predetermined sound source is located just rearward of the virtual camera has occurred. In this case, the sound source is not included in the field of view of the virtual camera and therefore is not displayed as a game image. Meanwhile, the distance between the virtual microphone and the sound source is a very close distance. Therefore, if the volume is determined on the basis of this distance, the volume is determined to be a large volume. As a result, a player suddenly hears some sound at a large volume even though the player does not see it in the game image. Thus, the player feels a sense of strangeness or unnaturalness with respect to the appearance of the game image.

Accordingly, an object of the present disclosure is to provide a computer-readable non-transitory storage medium having a sound processing program stored therein, an information processing system, an information processing apparatus, and a sound processing method that can prevent occurrence of such a situation that a large sound is suddenly heard from a position that cannot be seen on a screen, in a case of performing control while interlocking the positions of a virtual camera and a virtual microphone with each other in a third-person-view game.

Configuration examples for achieving the above object will be shown below.

### Configuration 1

Configuration 1 is a computer-readable non-transitory storage medium having stored therein a sound processing program for causing a computer of an information processing apparatus to execute the following processing. That is, the computer determines a position of a look-at point of a virtual camera in a virtual space on the basis of an operation input, controls a viewing direction of the virtual camera on the basis of the operation input, determines a position of the virtual camera on the basis of the position of the look-at point and the viewing direction, and determines a position of a virtual microphone in the virtual space, to be a position interlocked with the position of the virtual camera. Then, individually for at least one sound source placed in the virtual space, the computer determines a volume for outputting a sound set for the sound source, on the basis of a distance between the sound source and a volume reference position set at the position of the virtual microphone or a volume reference position set at a position shifted toward the look-at point side from the position of the virtual microphone in a case where the sound source is placed on a side opposite to the look-at point with respect to the virtual microphone, and outputs the sound set for the sound source on the basis of the determined volume.

In the above configuration example, it is possible to prevent such a situation that a large volume sound is suddenly heard from a sound source outside the field of view when the virtual microphone moves while interlocking with the viewing line of the virtual camera.

### Configuration 2

In configuration 2 based on the above configuration 1, the program may further cause the computer to, individually for the at least one sound source, determine localization of the sound set for the sound source, on the basis of a positional relationship between the virtual microphone and the sound source in the virtual space, and output the sound set for the sound source, on the basis of the determined localization and the determined volume.

In the above configuration example, the position of the virtual microphone is used as a reference for localization. Thus, it is possible to adjust only the volume without changing the position from which the sound is heard.

### Configuration 3

In configuration 3 based on the above configuration 2, the program may further cause the computer to, individually for the at least one sound source, determine the volume reference position to be any position on a line from the position of the virtual camera or the position of the virtual microphone to the position of the look-at point.

In the above configuration example, the volume reference position is determined to be any position between the look-at point and the virtual camera or the virtual microphone. Thus, it is possible to set a volume that hardly provides a sense of strangeness with respect to an image taken by the virtual camera and displayed on the screen.

### Configuration 4

In configuration 4 based on the above configuration 3, the program may further cause the computer to, individually for the at least one sound source, determine the volume reference position for the sound source to be a position that becomes closer to the look-at point on the line as the position of the sound source becomes closer to a direction opposite to a direction toward the look-at point with respect to the position of the virtual microphone.

In the above configuration example, as the sound source becomes closer to a position rearward of the virtual camera, the volume reference position is set to be shifted frontward of the virtual camera. Thus, it is possible to effectively prevent a large volume sound from being suddenly heard from a sound source present at a position that cannot be seen from the virtual camera.

### Configuration 5

In configuration 5 based on the above configuration 4, the program may further cause the computer to, individually for the at least one sound source, determine a degree in which the position of the sound source is close to the direction opposite to the direction toward the look-at point with respect to the position of the virtual microphone, on the basis of a difference between a first direction from the position of the virtual camera or the virtual microphone to the look-at point and a second direction from said position to the sound source, and determine the volume reference position for the sound source to be a position that becomes closer to the look-at point on the line as the degree becomes higher.

In the above configuration example, the degree in which the position of the sound source is close to the direction opposite to the direction toward the look-at point with respect to the position of the virtual microphone is determined using the difference between two directions that are the look-at-point direction and the sound source direction. Thus, it is possible to appropriately calculate the degree while reducing the load of calculation processing.

### Configuration 6

In configuration 6 based on the above configuration 5, the program may further cause the computer to, individually for the at least one sound source, determine the volume reference position to be at the position of the look-at point by setting the degree to be maximized in a case where an angle between the first direction and the second direction is in a predetermined range including 180 degrees.

In the above configuration example, volume calculation can be performed using the look-at-point position as a reference uniformly for sound sources in a predetermined range where the angle between the first direction and the second direction is around 180 degrees so that this range is definitely not included in the field of view of the virtual camera. Thus, it is possible to prevent a large sound from being suddenly heard from a position that cannot be seen, while reducing the processing load.

### Configuration 7

In configuration 7 based on the above configuration 6, the program may further cause the computer to, individually for the at least one sound source, determine the volume reference position to be at the position of the virtual microphone by setting the degree to be minimized in a case where the angle between the first direction and the second direction is in a predetermined range including 0 degrees.

In the above configuration example, volumes can be determined using the position of the virtual microphone as a reference uniformly for sound sources present in directions close to the look-at-point direction to a certain extent. When a sound source is present in a direction close to the look-at-point direction, the sound source is necessarily included in the field of view of the virtual camera. Therefore, for example, if the predetermined range is set to be the same range as the angle of view of the virtual camera, volumes can be determined using the position of the virtual microphone as a reference uniformly for sound sources displayed on the screen. Thus, it is possible to make such a sound expression that there is no sense of strangeness with respect to the appearance displayed as the game screen and prevent a player from feeling a sense of strangeness.

### Configuration 8

In configuration 8 based on any one of the above configurations 1 to 7, the program may further cause the computer to: control a player character in the virtual space on the basis of the operation input: and determine the position of the look-at point so as to follow a position of the player character.

In the above configuration example, the volume reference position is determined to be any position between the player character and the virtual camera or the virtual microphone. Therefore, a player can feel, for the volume, as if the position of the sound source were present at the position of the virtual camera or the player character or at any position therebetween. Thus, it is possible to set such a volume that hardly provides a sense of strangeness with respect to the appearance of an image taken by the virtual camera. In particular, this configuration is further effective for third-person-view information processing in which a player character is set at the look-at point.

According to the present disclosure, it is possible to prevent occurrence of such a situation that a large volume sound is suddenly heard from a sound source outside the field of view of a virtual camera in a case where a virtual microphone moves while interlocking with the viewing line of the virtual camera.

### BRIEF DESCRIPTION OF THE DRAWINGS

FIG. 1 is a block diagram showing a non-limiting example of the internal configuration of a game apparatus 2;

FIG. 2 shows a non-limiting example of a game screen according to the exemplary embodiment;

FIG. 3 is a schematic view showing a non-limiting example of a virtual game space as seen from above;

FIG. 4 shows a non-limiting example of movement of a virtual microphone;

FIG. 5 illustrates a non-limiting example of the principle of processing in the exemplary embodiment;

FIG. 6 illustrates a non-limiting example of the principle of processing in the exemplary embodiment;

FIG. 7 illustrates a non-limiting example of the principle of processing in the exemplary embodiment;

FIG. 8 illustrates a non-limiting example of the principle of processing in the exemplary embodiment;

FIG. 9 illustrates a non-limiting example of the principle of processing in the exemplary embodiment;

FIG. 10 illustrates a non-limiting example of the principle of processing in the exemplary embodiment;

FIG. 11 illustrates a non-limiting example of the principle of processing in the exemplary embodiment;

FIG. 12 illustrates a non-limiting example of the principle of processing in the exemplary embodiment;

FIG. 13 is a memory map showing a non-limiting example of various data stored in a storage section 84;

FIG. 14 shows a non-limiting example of the data structure of sound source object data 304;

FIG. 15 is a non-limiting example flowchart showing the details of game processing according to the exemplary embodiment;

FIG. 16 is a non-limiting example flowchart showing the details of game processing according to the exemplary embodiment;

FIG. 17 illustrates a non-limiting example of modification; and

FIG. 18 illustrates a non-limiting example of modification.

### DETAILED DESCRIPTION OF NON-LIMITING EXAMPLE EMBODIMENTS

Hereinafter, an exemplary embodiment will be described.

### Hardware Configuration of Information Processing Apparatus

First, an information processing apparatus for executing information processing according to the exemplary embodiment will be described. The information processing apparatus is, for example, a smartphone, a stationary or hand-held game apparatus, a tablet terminal, a mobile phone, a personal computer, a wearable terminal, or the like. In addition, the information processing according to the exemplary embodiment can also be applied to a game system that includes the above game apparatus or the like and a predetermined server. In the exemplary embodiment, a stationary game apparatus (hereinafter, referred to simply as a game apparatus) will be described as an example of the information processing apparatus. In addition, game processing will be described as an example of the information processing.

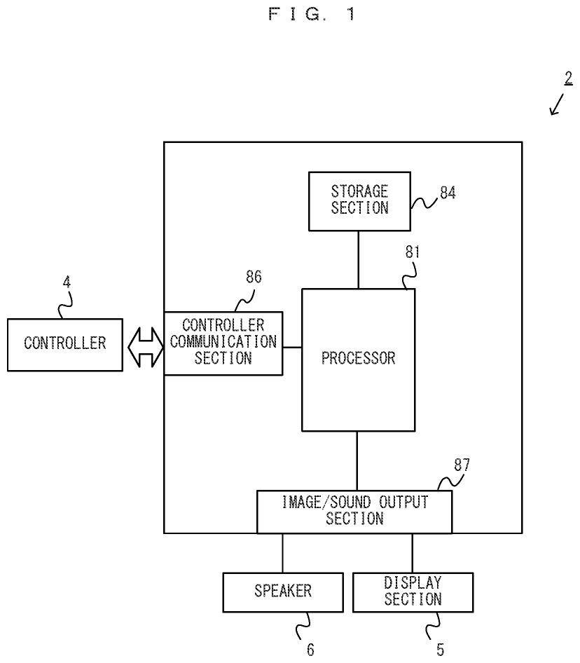

FIG. 1 is a block diagram showing an example of the internal configuration of a game apparatus 2 according to the exemplary embodiment. The game apparatus 2 includes a processor 81. The processor 81 is an information processing section for executing various types of information processing to be executed by the game apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 performs the various types of information processing by executing an information processing program (e.g., a game program) stored in a storage section 84. The storage section 84 may be, for example, an internal storage medium such as a flash memory and a dynamic random access memory (DRAM), or may be configured to utilize an external storage medium mounted to a slot that is not shown, or the like. The game apparatus 2 also includes a controller communication section 86 for the game apparatus 2 to perform wired or wireless communication with a controller 4. Although not shown, the controller 4 is provided with various buttons such as a cross key and A, B, X, and Y buttons, an analog stick, etc.

Moreover, a display section 5 (for example, a liquid crystal monitor, or the like) and a speaker 6 are connected to the game apparatus 2 via an image/sound output section 87. The processor 81 outputs an image generated (for example, by executing the above information processing) to the display section 5 via the image/sound output section 87. In addition, the processor 81 outputs a generated sound (signal) to the speaker 6 via the image/sound output section 87.

### Outline of Game Processing in Exemplary Embodiment

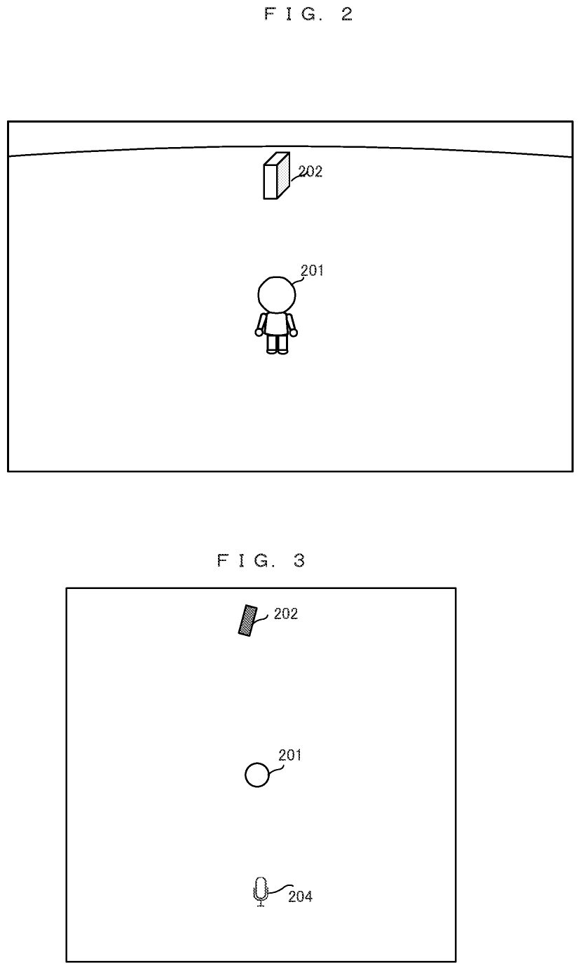

Next, the outline of operation in game processing executed by the game apparatus 2 according to the exemplary embodiment will be described. First, a game assumed in the exemplary embodiment is a game in which a player character object (hereinafter, referred to as player character) is operated in a virtual three-dimensional game space (hereinafter, referred to as virtual game space). FIG. 2 shows an example of a game screen in this game. In FIG. 2, a player character 201 and a sound source object (hereinafter, simply referred to as sound source) 202 are displayed. As shown in FIG. 2, this game progresses on a screen based on a third-person view. In this game, the player character 201 is set at the look-at point of a virtual camera. The virtual camera is placed at a position away rearward from the player character by a predetermined distance, as a default placement position. In the example in FIG. 2, the virtual camera is placed at such a distance that the entire body of the player character 201 is displayed substantially at the center of the screen.

In addition, a virtual microphone is also placed at the position of the virtual camera. The virtual microphone is used for acquiring a sound emitted from the sound source 202 placed in the virtual game space, and outputting a sound signal having undergone predetermined sound-related processing, to the speaker. The virtual microphone may be called an “audio listener” or simply a “listener”.

FIG. 3 is a schematic view of the virtual game space in the situation shown in FIG. 2 as seen from above and shows a non-limiting example of the positional relationship between the virtual microphone and the player character 201. In FIG. 3, the virtual camera is also present at the position of the virtual microphone, although not shown. In FIG. 3, the sound source 202 is present frontward of the player character 201, and the virtual microphone 204 is placed at a position away rearward from the player character 201 by a predetermined distance.

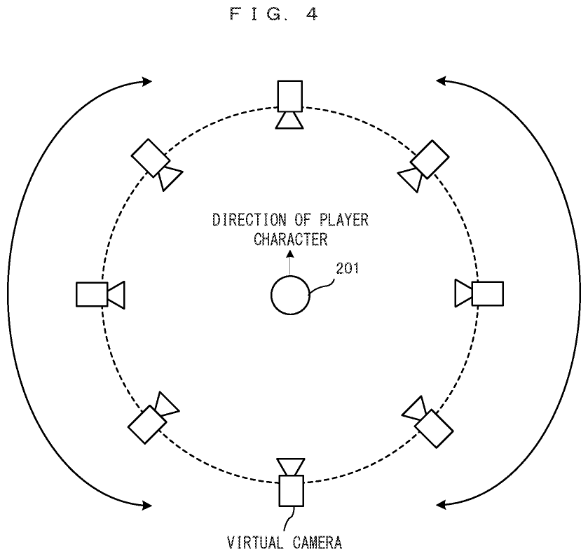

Here, this game is configured such that the virtual microphone and the virtual camera are interlocked with each other. For example, when the player character 201 moves, the virtual camera and the virtual microphone move so as to follow the player character corresponding to the look-at point. In a state in which the player character 201 is not moving, as shown in FIG. 4, the virtual camera may be moved along a circumference centered at the player character 201 corresponding to the look-at point. Then, since the position of the virtual microphone is the same as the position of the virtual camera, the virtual microphone also moves in a circular form together with the virtual camera. In other words, the virtual microphone moves while interlocking with the viewing line of the virtual camera. Such circular movements of the virtual camera and the virtual microphone can be performed in a predetermined event scene or demonstration scene, for example. In addition, movements of the virtual camera and the virtual microphone as shown in FIG. 4 can be performed also through operation of directly moving the virtual camera by the player, for example. For example, in a state in which the player character 201 is not moving, it is possible to perform such movement of the virtual camera by the player performing a left/right direction input on a direction input key or an analog stick assigned for virtual camera control.

Here, while the virtual camera and the virtual microphone are moving, e.g., while they are moving in a circular form centered at the look-at point as described above, as shown in FIG. 5, a situation in which the virtual microphone 204 passes just near the sound source 202 can occur. In the example in FIG. 5, the virtual microphone 204 passes through a position slightly shifted toward the player character 201 from the sound source 202. In this case, the distance between the virtual microphone 204 and the sound source 202 is very close, and therefore, if the volume is determined in accordance with this distance, the volume of a sound emitted from the sound source 202 becomes large. Meanwhile, the look-at point of the virtual camera is at the player character 201, and therefore, in the positional relationship as shown in FIG. 5, the sound source 202 is not included in the field of view of the virtual camera and thus is not displayed on the screen. In this case, it may seem to the player that some sound is heard at a large volume even though nothing like a sound source is displayed around the player character 201 on the screen. For example, in a case where the virtual camera is moving in a circular form at a high speed around the player character 201, the player may suddenly hear some large sound even though no such thing is displayed on the screen, and soon after that, may no longer hear the sound. As a result, the player might feel a sense of strangeness or unnaturalness with respect to contents visually recognized on the screen. Accordingly, in the exemplary embodiment, in order to reduce a sense of strangeness or the like about the volume in such a situation as described above, the following sound control is performed.

### Outline of Processing According to the Exemplary Embodiment

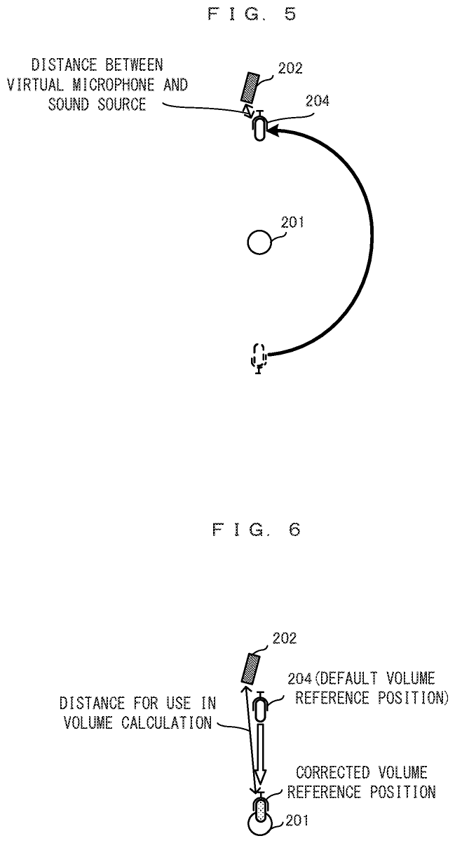

In the exemplary embodiment, the volume of a sound emitted from a certain sound source is determined on the basis of the linear distance between the sound source and a “volume reference position”. The default position of the volume reference position is the position of the virtual microphone. That is, the volume is basically determined on the basis of the distance between the sound source and the virtual microphone. Then, in the exemplary embodiment, the volume reference position is determined to be any position on a line from the virtual microphone to the player character, through processing described below. For example, as shown in FIG. 6, control is performed so as to correct the volume reference position to a position shifted toward the look-at point from the default position. In other words, control is performed so as to change the “distance” which is the basis for determining the volume. Hereinafter, the outline of a method for determining the volume reference position in the exemplary embodiment will be described.

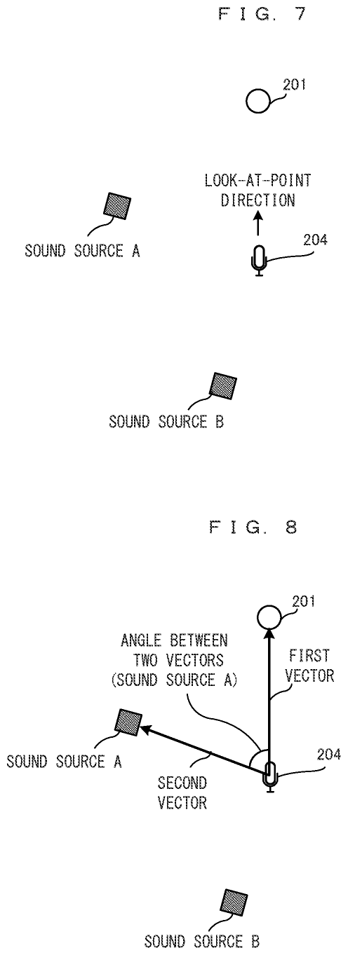

In the exemplary embodiment, a “rearward degree” is obtained for each sound source, and the volume reference position is determined on the basis of the “rearward degree”. The “rearward degree” is an index indicating the degree in which, with the look-at-point direction defined as a frontward direction, the position of the sound source is close to the direction opposite to the look-at-point direction with respect to the position of the virtual microphone. In other words, the index indicates to what degree the position of the sound source comes around to the rearward side from the frontward side, as seen from the virtual microphone. In the exemplary embodiment, the “rearward degree” is the highest when the positional relationship is such that the position of the sound source is in the direction directly opposite to the look-at-point direction. Specifically, the “rearward degree” is obtained in the following way. First, as an example for explanation, a positional relationship as shown in FIG. 7 is assumed. In FIG. 7, the player character 201, the virtual microphone 204, a sound source A, and a sound source B are shown. In addition, the virtual camera is also placed at the position of the virtual microphone 204, although not shown. The look-at point is at the player character 201. The virtual microphone 204 is located rearward of the player character 201. The sound source A is present at an obliquely left rear position as seen from the position of the player character 201, and at an obliquely left front position as seen from the virtual microphone. The sound source B is present at a position slightly shifted leftward from the directly rearward side of the player character 201 and the virtual microphone 204. The sound source A and the sound source B are not included in the field of view of the virtual camera. Using such a positional relationship as an example, description will be given below.

First, regarding the sound source A, as shown in FIG. 8, a first vector extending from the virtual microphone 204 to the player character 201 (look-at point) is obtained. The first vector is a vector indicating the look-at-point direction of the virtual camera, i.e., the viewing direction. Then, a second vector extending from the virtual microphone 204 to the sound source A is obtained. Further, an angle between the two vectors is obtained. In this example, the angle between the two vectors is obtained with the direction of the first vector defined as 0 degrees.

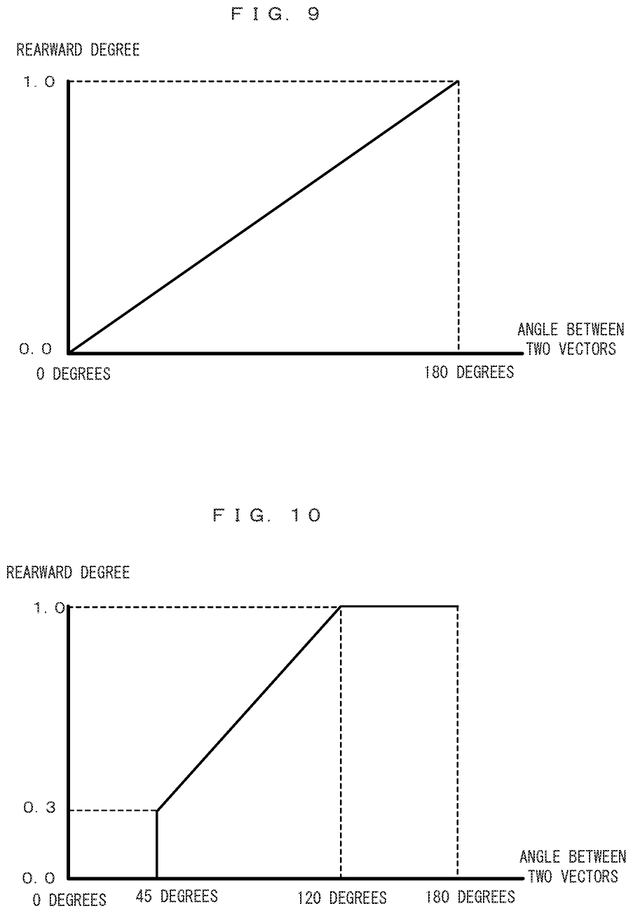

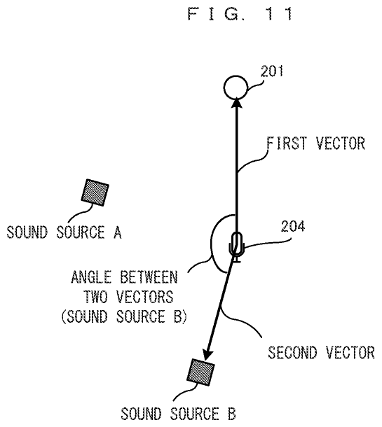

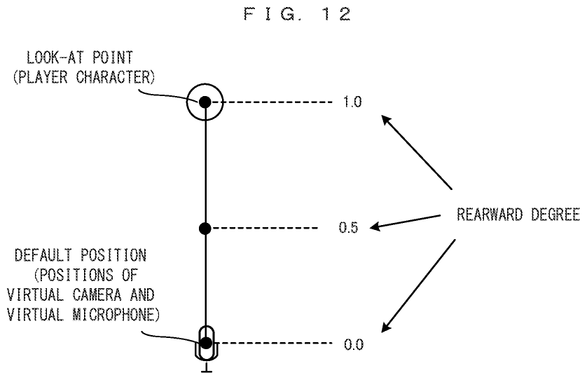

Next, the “rearward degree” for the sound source A is determined on the basis of the angle between the two vectors. In the exemplary embodiment, the “rearward degree” is a value in a range of 0.0 to 1.0. In this value range, the “rearward degree” is determined to be “0.0” when the angle between the two vectors is 0 degrees and “1.0” when the angle between the two vectors is 180 degrees. Here, the correspondence relationship between the “rearward degree” and the angle between the two vectors may be a linear correspondence relationship as shown in a graph in FIG. 9, or the “rearward degree” may be set at the same value in a certain range of angles as shown in a graph in FIG. 10. In both graphs, the vertical axis indicates the “rearward degree” and the horizontal axis indicates the angle between the two vectors. In the example in FIG. 10, the “rearward degree” is set at 1.0 when the angle between the two vectors is in a range of 120 degrees to 180 degrees which is a predetermined range including 180 degrees. In addition, the “rearward degree” is set at 0.0 when the angle between the two vectors is in a range of 0 degrees to 45 degrees which is a predetermined range including 0 degrees. The “rearward degree” is obtained from the angle between the two vectors on the basis of the correspondence relationship as shown in the graph in FIG. 9 or FIG. 10.

Further, regarding the sound source B, the “rearward degree” is obtained in the same manner as described above. Specifically, as shown in FIG. 11, a first vector extending from the virtual microphone 204 to the player character 201 is obtained. Alternatively, the first vector obtained for the above sound source A may be used. Then, a second vector extending from the virtual microphone 204 to the sound source B is obtained. Further, the angle between the two vectors is obtained. Then, the “rearward degree” is obtained from the angle between the two vectors on the basis of the correspondence relationship as shown in the graph in FIG. 9 or FIG. 10.

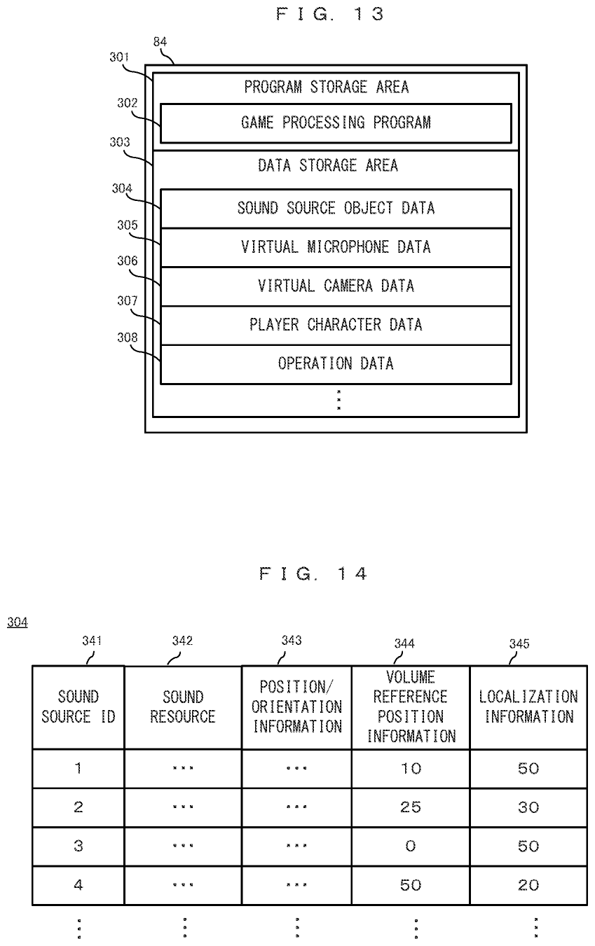

After the “rearward degree” for each sound source is determined as described above, next, the volume reference position is determined for each sound source in accordance with the “rearward degree”. In the exemplary embodiment, as shown in FIG. 12, the volume reference position is determined to be the default position (the position of the virtual microphone) when the “rearward degree” is “0.0”, and to be the position of the player character (look-at point) when the “rearward degree” is “1.0”. In other words, control is performed such that the volume reference position is more moved in the look-at-point direction from the position of the virtual microphone which is the default position, as the “rearward degree” becomes higher. Therefore, for example, when the “rearward degree” is “0.5”, the volume reference position is determined to be approximately a middle position between the player character and the virtual microphone. The correspondence relationship between the “rearward degree” and the volume reference position (the movement amount from the default position) may also be a linear correspondence relationship or the volume reference position may be set at the same value in a certain range of “rearward degrees”, as in the graph in FIG. 9 or FIG. 10 described above.

The volume reference position is just used for determining the volume, and other elements such as localization are determined with reference to the position (default position) of the virtual microphone. For example, for a sound heard from the sound source B, the volume can be adjusted using the volume reference position as described above, whereas the direction in which the sound is heard is determined considering the positional relationship with the virtual microphone, to make such a sound expression that the sound is heard from a leftward shifted position.

### Details of Game Processing in the Exemplary Embodiment

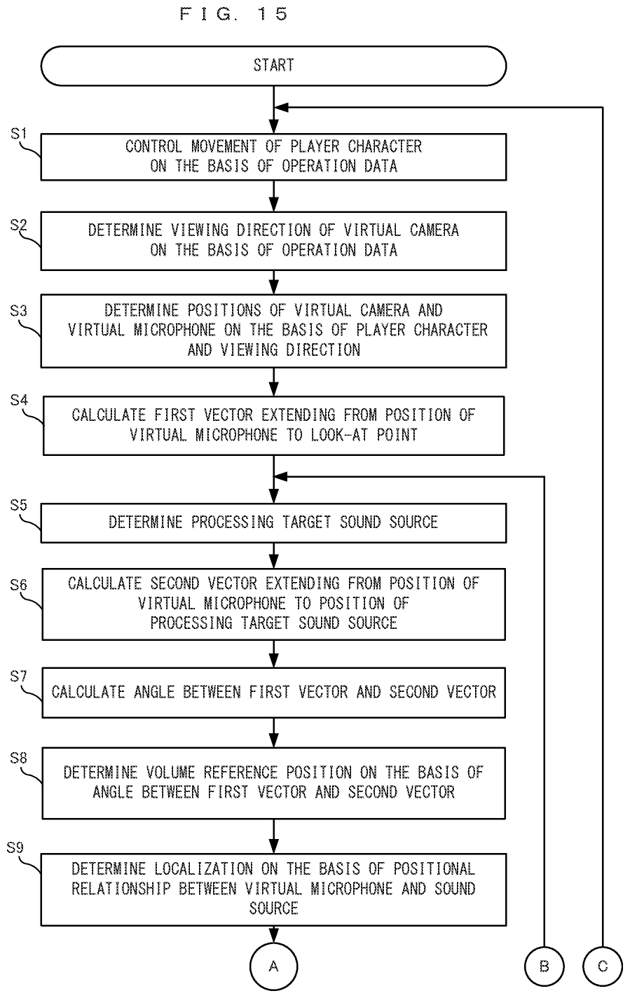

Next, with reference to FIG. 13 to FIG. 16, the game processing in the exemplary embodiment will be described in more detail.

### Used Data

First, various data used in this game processing will be described. FIG. 13 is a memory map showing a non-limiting example of various data stored in the storage section 84 of the game apparatus 2. The storage section 84 includes a program storage area 301 and a data storage area 303. In the program storage area 301, a game processing program 302 is stored. In the data storage area 303, sound source object data 304, virtual microphone data 305, virtual camera data 306, player character data 307, operation data 308, and the like are stored.

The game processing program 302 is a program for executing the game processing according to the exemplary embodiment, and includes program codes for executing control relevant to volume determination as described above.

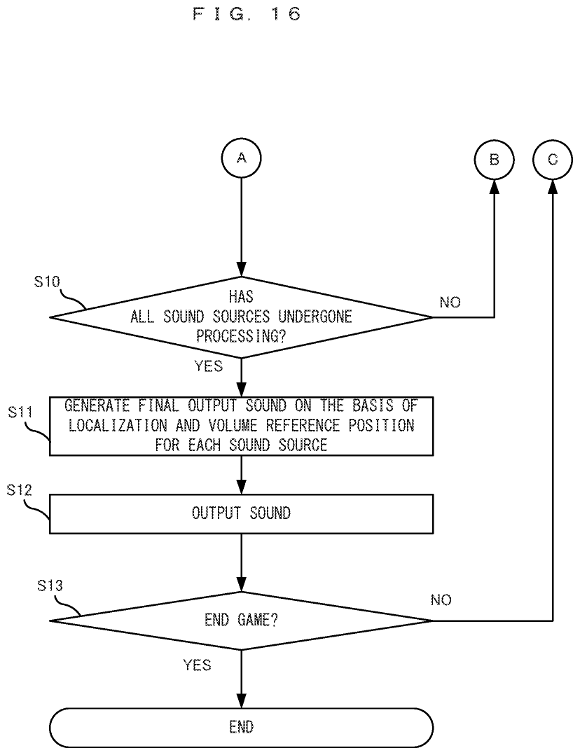

The sound source object data 304 is data relevant to the sound source 202 that can be placed in the virtual space. FIG. 14 shows a non-limiting example of the data structure of the sound source object data 304. The sound source object data 304 is a database constituted of records including at least a sound source ID 341, a sound resource 342, position/orientation information 343, volume reference position information 344, and localization information 345. The sound source ID 341 is an ID for uniquely identifying each sound source. The sound resource 342 is sound data as a resource for sounds to be reproduced. The position/orientation information 343 is data indicating the position and the orientation of the sound source 202 in the virtual game space. The volume reference position information 344 is information indicating the volume reference position as described above. For example, the volume reference position information 344 may be represented as a relative distance or a movement amount for linearly moving from the position of the virtual microphone to the position of the player character, or may be represented as coordinates in the virtual space. The localization information 345 is information indicating localization of a sound heard from the sound source. For example, the localization information 345 may be represented as a value in a predetermined range with the maximum value assigned as “right” and the minimum value assigned as “left”.

Returning to FIG. 13, the virtual microphone data 305 is data relevant to the virtual microphone. The virtual microphone data 305 includes information indicating the position and the orientation of the virtual microphone. In the exemplary embodiment, the position and the orientation of the virtual microphone are the same as those of the virtual camera, as described above.

The virtual camera data 306 is data for specifying the position, the orientation, the angle of view, and the like of the virtual camera at present.

The player character data 307 is data relevant to the player character. The player character data 307 includes information indicating the position and the orientation of the player character in the virtual space, information indicating the appearance thereof, and the like.

The operation data 308 is data indicating the content of an operation performed on the controller 4. In the exemplary embodiment, the operation data 308 includes data indicating the press states on buttons such as the cross key and the input state on the analog stick provided to the controller 4. The content of the operation data 308 is updated at a predetermined cycle on the basis of a signal from the controller 4.

Other than the above, the storage section 84 stores various data used in the game processing, as necessary.

### Details of Processing Executed by Processor 81

Next, the details of the game processing according to the exemplary embodiment will be described. Here, processing relevant to control for volume determination as described above will be mainly described, and detailed description of other game processing is omitted.

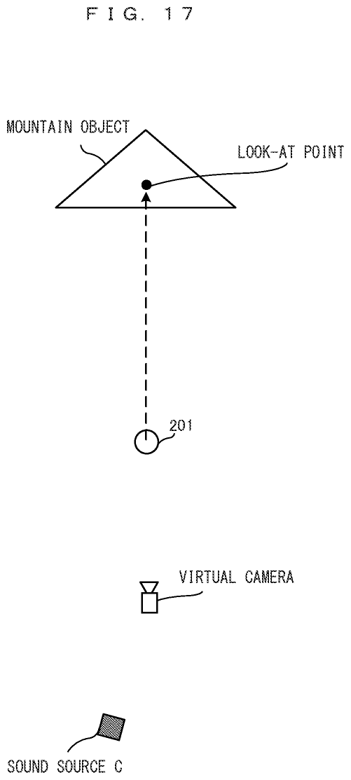

FIG. 15 and FIG. 16 are non-limiting example flowcharts showing the details of the game processing according to the exemplary embodiment. In the exemplary embodiment, the flowcharts are implemented by one or more processors reading and executing the programs stored in one or more memories. A processing loop from step S1 to step S13 shown in the flowcharts is repeatedly executed every frame. The flowcharts are merely an example of the processing procedure. Therefore, the processing order of the steps may be changed as long as the same result is obtained. The values of variables and thresholds used in determination steps are also merely examples, and other values may be employed as necessary.

When the game processing according to the exemplary embodiment is started, first, in step S1, the processor 81 acquires the operation data 308. Then, the processor 81 performs movement control for the player character on the basis of the operation content. Thus, the position of the player character can be changed.

Next, in step S2, the processor 81 determines the viewing direction of the virtual camera, in other words, the orientation of the virtual camera, on the basis of the operation data 308. In a case of automatically controlling movement of the virtual camera without depending on a player's operation in an event scene or the like, information corresponding to a content for automatic movement may be used instead of the operation data 308.

Next, in step S3, the processor 81 determines the position of the virtual camera on the basis of the viewing direction of the virtual camera and the position of the player character corresponding to the look-at point. Further, the processor 81 determines the position of the virtual microphone to be at the position of the virtual camera. Then, the processor 81 updates the contents of the virtual camera data 306 and the virtual microphone data 305 by the determined contents. Thus, when the player character is moving, movement control is performed so as to follow the player character. When the player character is not moving, the virtual camera can be moved as shown in FIG. 4, for example.

Next, in step S4, the processor 81 calculates the first vector as described above. That is, the processor 81 calculates a vector extending from the position of the virtual microphone to the position of the player character, as the first vector.

Next, for each sound source, processing of determining the volume reference position as described above is executed. Specifically, first, in step S5, the processor 81 determines one processing target sound source which is a target of processing described below, from among the sound sources 202 present in a predetermined range defined as a sound collection range of the virtual microphone.

Next, in step S6, the processor 81 calculates the second vector for the processing target sound source. That is, the processor 81 calculates a vector extending from the position of the virtual microphone to the position of the processing target sound source, as the second vector.

Next, in step S7, the processor 81 calculates the angle between the first vector and the second vector.

Next, in step S8, the processor 81 determines the “rearward degree” on the basis of the angle between the first vector and the second vector, and the graph as shown in FIG. 9 or FIG. 10. Further, the processor 81 determines the volume reference position on the basis of the “rearward degree”. Then, the processor 81 stores the determined volume reference position as the volume reference position information 344 for the processing target sound source.

Next, in step S9, the processor 81 determines localization of the processing target sound source on the basis of the positional relationship between the virtual microphone and the processing target sound source. Then, the processor 81 stores the determined localization as the localization information 345 for the processing target sound source.

Next, in step S10 in FIG. 16, the processor 81 determines whether or not the process from step S5 to step S9 has been performed for all the sound sources 202 present in the sound collection range of the virtual microphone. If there is a sound source that has not undergone the processing yet (NO in step S10), the processor 81 returns to step S5 to repeat the process. On the other hand, if all the sound sources have undergone the processing (YES in step S10), in step S11, the processor 81 generates an output sound to be finally outputted, on the basis of the volume reference position information 344 and the localization information 345 for each sound source. That is, the processor 81 determines the volume of a sound for each sound source on the basis of the volume reference position information 344 for the sound source. Further, the processor 81 determines localization of the sound for each sound source on the basis of the localization information 345. Then, the processor 81 generates the sound for each sound source by the determined volume and localization, and synthesizes these sounds to generate the output sound.

Next, in step S12, the processor 81 outputs the output sound to the speaker 6. At this time, processing such as outputting an image of the game space taken by the virtual camera as a game image is also performed.

Next, in step S13, the processor 81 determines whether or not a condition for ending the game processing is satisfied. For example, whether or not a game ending instruction operation has been performed by the player is determined. If the condition is not satisfied (NO in step S13), the processor 81 returns to step S1 to repeat the process. On the other hand, if the condition is satisfied (YES in step S13), the processor 81 ends the game processing.

Thus, the detailed description of the game processing according to the exemplary embodiment has been finished.

As described above, in the exemplary embodiment, for each sound source, the volume reference position is determined on the basis of the “rearward degree”. The volume reference position is determined to be any position on a line from the virtual microphone to the look-at point. Then, the volume for each sound source is determined on the basis of the distance between the volume reference position and the virtual microphone. Thus, it is possible to prevent occurrence of such a situation that a large volume sound is suddenly heard from a sound source outside the field of view of the virtual camera in a case where the virtual microphone moves while interlocking with the viewing line of the virtual camera. For example, when a sound source is present on a line extending in the look-at-point direction from the virtual microphone, the rearward degree is “0.0”. In this case, the volume is determined on the basis of the actual distance between the virtual microphone and the sound source in the virtual space. In addition, when the sound source is present on the line extending in the look-at-point direction from the virtual microphone, the sound source is necessarily included in the field of view of the virtual camera. As a result, a sound expression is made such that there is no sense of strangeness with respect to the appearance displayed as a game screen. On the other hand, when the rearward degree is “1.0”, the sound source is present in the direction directly opposite to the look-at-point direction. Then, since the sound source is present in the direction directly opposite to the look-at-point direction, the sound source is not included in the field of view of the virtual camera and thus is not displayed on the game screen. In this case, even if the distance between the virtual microphone and this sound source that cannot be seen is a very close distance, the distance between the sound source and the look-at point determined as the volume reference position is used as a distance that is a base for volume determination. As a result, for example, even in a situation in which the sound source is present just rearward of the virtual camera and the virtual microphone, a sound is heard with such a volume as if the virtual microphone were present at the position of the player character corresponding to the look-at point. Thus, it is possible to prevent occurrence of such a situation that, in particular, while the virtual camera and the virtual microphone are moving, a large sound is suddenly heard when the virtual microphone passes by such a sound source that cannot be seen and thus the player feels a sense of strangeness with respect to the appearance of the game image.

### Modifications

In the above exemplary embodiment, the case where the position of the virtual microphone is the same as the position of the virtual camera has been shown. In another exemplary embodiment, the position of the virtual microphone may be a position shifted from the position of the virtual camera by a predetermined distance. Alternatively, in another exemplary embodiment, the position of the virtual microphone may be controlled so as to follow the virtual camera. In a case where the positions of the virtual camera and the virtual microphone do not coincide with each other, the volume reference position may be determined to be a position on a line from the virtual microphone to the look-at point or may be determined to be a position on a line from the virtual camera to the look-at point.

In the above exemplary embodiment, the method of using the angle between the first vector and the second vector in determination for the “rearward degree” has been shown. Without limitation to calculation of the angle as described above, any method may be used as long as the difference between a first direction from the virtual microphone to the look-at point and a second direction from the virtual microphone to the sound source is determined and the “rearward degree” as described above can be determined on the basis of the difference.

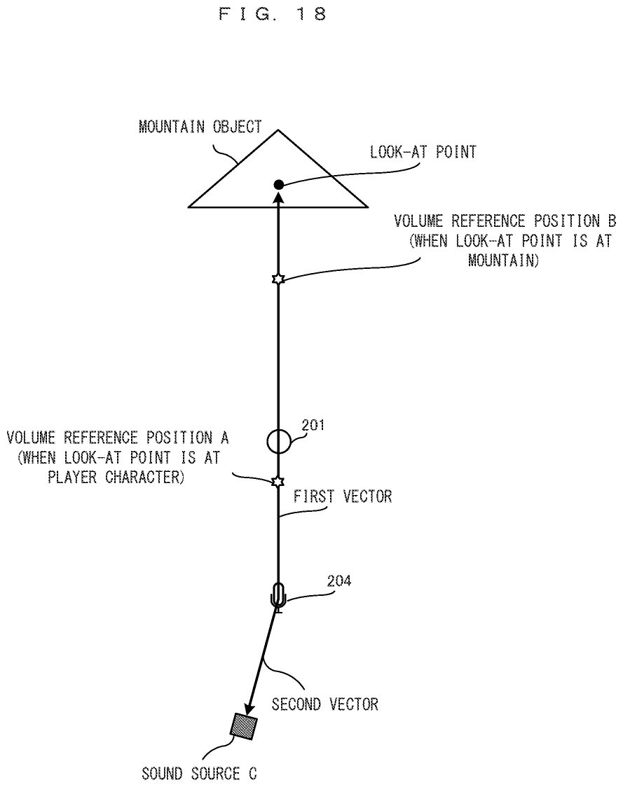

In the above exemplary embodiment, the default position of the volume reference position is set at the position of the virtual microphone, and the default position is corrected in the look-at-point direction in accordance with the “rearward degree”. In this regard, in another exemplary embodiment, an upper limit may be set for the amount of the correction. For example, it is assumed that, during the game, the look-at point of the virtual camera is temporarily changed from the player character to another object. As an example, in an event scene or the like, as shown in FIG. 17, it is assumed that the look-at point of the virtual camera is changed from the player character 201 to a mountain object present at a far position in the frontward direction. In this case, according to the above processing, the volume reference position is determined to be on a line from the virtual microphone to the mountain object. At this time, if the above processing is directly applied, for a sound source C in FIG. 17, the corrected volume reference position can differ between a case where the look-at point is at the player character 201 and a case where the look-at point is at the mountain object. That is, even when the angle between the first vector and the second vector is the same, if the linear distance from the virtual microphone to the look-at point differs, the distance from the default position to the corrected volume reference position can differ. For example, as shown in FIG. 18, in a case where the look-at point is at the player character 201, the corrected volume reference position can be a volume reference position A, and in a case where the look-at point is at the mountain object, the corrected volume reference position can be a volume reference position B. Therefore, when the look-at point is temporarily changed to the mountain object, the volume of a sound from the sound source C can be determined on the basis of the volume reference position B. As a result, when the look-at point is changed, unnatural volume change might occur, for example, so that the player might feel a sense of strangeness. Therefore, an upper limit may be set for the amount of correction for the volume reference position. For example, the position of the player character 201 may be used as an upper limit for the correction amount. Alternatively, an upper limit may be set for the value of the correction amount. Thus, it is possible to prevent the player from feeling a sense of strangeness about the volume even when the look-at point is changed.

In the above exemplary embodiment, the case where the sequential processing in the game processing is executed by a single game apparatus 2 has been described. In another exemplary embodiment, the sequential processing may be executed in an information processing system including a plurality of information processing apparatuses. For example, in an information processing system including a terminal-side apparatus and a server-side apparatus that can communicate with the terminal-side apparatus via a network, a part of the sequential processing may be executed by the server-side apparatus. In an information processing system including a terminal-side apparatus and a server-side apparatus that can communicate with the terminal-side apparatus via a network, a major part of the sequential processing may be executed by the server-side apparatus and a part of the sequential processing may be executed by the terminal-side apparatus. In the information processing system, a server-side system may include a plurality of information processing apparatuses and processing to be executed on the server side may be executed by the plurality of information processing apparatuses in a shared manner. A configuration of so-called cloud gaming may be adopted. For example, the game apparatus 2 may transmit operation data indicating a player's operation to a predetermined server, various game processing may be executed on the server, and the execution result may be distributed as a video and a sound by streaming to the game apparatus 2.

While the present disclosure has been described herein, it is to be understood that the above description is, in all aspects, merely an illustrative example, and is not intended to limit the scope thereof. It is to be understood that various modifications and variations can be made without deviating from the scope of the present disclosure.

What is claimed is:

1. A computer-readable non-transitory storage medium having stored therein a sound processing program for causing a computer of an information processing apparatus to:
determine a position of a look-at point of a virtual camera in a virtual space on the basis of an operation input;
control a viewing direction of the virtual camera on the basis of the operation input;
determine a position of the virtual camera on the basis of the position of the look-at point and the viewing direction;
determine a position of a virtual microphone in the virtual space, to be a position interlocked with the position of the virtual camera; and
individually for at least one sound source placed in the virtual space,
determine a volume for outputting a sound set for the sound source, on the basis of a distance between the sound source and a volume reference position which is set at the position of the virtual microphone or which is set at a position shifted toward the look-at point side from the position of the virtual microphone in a case where the sound source is placed on a side opposite to the look-at point with respect to the virtual microphone, and
output the sound set for the sound source on the basis of the determined volume.

2. The computer-readable non-transitory storage medium according to claim 1, the program further causing the computer to:
individually for the at least one sound source,
determine localization of the sound set for the sound source, on the basis of a positional relationship between the virtual microphone and the sound source in the virtual space, and
output the sound set for the sound source, on the basis of the determined localization and the determined volume.

3. The computer-readable non-transitory storage medium according to claim 2, the program further causing the computer to:
individually for the at least one sound source, determine the volume reference position to be any position on a line from the position of the virtual camera or the position of the virtual microphone to the position of the look-at point.

4. The computer-readable non-transitory storage medium according to claim 3, the program further causing the computer to:
individually for the at least one sound source, determine the volume reference position for the sound source to be a position that becomes closer to the look-at point on the line as the position of the sound source becomes closer to a direction opposite to a direction toward the look-at point with respect to the position of the virtual microphone.

5. The computer-readable non-transitory storage medium according to claim 4, the program further causing the computer to:
individually for the at least one sound source,
determine a degree in which the position of the sound source is close to the direction opposite to the direction toward the look-at point with respect to the position of the virtual microphone, on the basis of a difference between a first direction from the position of the virtual camera or the virtual microphone to the look-at point and a second direction from said position to the sound source, and
determine the volume reference position for the sound source to be a position that becomes closer to the look-at point on the line as the degree becomes higher.

6. The computer-readable non-transitory storage medium according to claim 5, the program further causing the computer to:
individually for the at least one sound source, determine the volume reference position to be at the position of the look-at point by setting the degree to be maximized in a case where an angle between the first direction and the second direction is in a predetermined range including 180 degrees.

7. The computer-readable non-transitory storage medium according to claim 6, the program further causing the computer to:
individually for the at least one sound source, determine the volume reference position to be at the position of the virtual microphone by setting the degree to be minimized in a case where the angle between the first direction and the second direction is in a predetermined range including 0 degrees.

8. The computer-readable non-transitory storage medium according to claim 1, the program further causing the computer to:
control a player character in the virtual space on the basis of the operation input; and
determine the position of the look-at point so as to follow a position of the player character.

9. An information processing system comprising a processor, the processor being configured to:
determine a position of a look-at point of a virtual camera in a virtual space on the basis of an operation input;
control a viewing direction of the virtual camera on the basis of the operation input;
determine a position of the virtual camera on the basis of the position of the look-at point and the viewing direction;
determine a position of a virtual microphone in the virtual space, to be a position interlocked with the position of the virtual camera; and
individually for at least one sound source placed in the virtual space,
determine a volume for outputting a sound set for the sound source, on the basis of a distance between the sound source and a volume reference position which is set at the position of the virtual microphone or which is set at a position shifted toward the look-at point side from the position of the virtual microphone in a case where the sound source is placed on a side opposite to the look-at point with respect to the virtual microphone, and
output the sound set for the sound source on the basis of the determined volume.

10. The information processing system according to claim 9, the processor being further configured to:
individually for the at least one sound source,
determine localization of the sound set for the sound source, on the basis of a positional relationship between the virtual microphone and the sound source in the virtual space; and
output the sound set for the sound source, on the basis of the determined localization and the determined volume.

11. The information processing system according to claim 10, the processor being further configured to:
individually for the at least one sound source, determine the volume reference position to be any position on a line from the position of the virtual camera or the position of the virtual microphone to the position of the look-at point.

12. The information processing system according to claim 11, the processor being further configured to:
individually for the at least one sound source, determine the volume reference position for the sound source to be a position that becomes closer to the look-at point on the line as the position of the sound source becomes closer to a direction opposite to a direction toward the look-at point with respect to the position of the virtual microphone.

13. The information processing system according to claim 12, the processor being further configured to:
individually for the at least one sound source,
determine a degree in which the position of the sound source is close to the direction opposite to the direction toward the look-at point with respect to the position of the virtual microphone, on the basis of a difference between a first direction from the position of the virtual camera or the virtual microphone to the look-at point and a second direction from said position to the sound source, and
determine the volume reference position for the sound source to be a position that becomes closer to the look-at point on the line as the degree becomes higher.

14. The information processing system according to claim 13, the processor being further configured to:
individually for the at least one sound source, determine the volume reference position to be at the position of the look-at point by setting the degree to be maximized in a case where an angle between the first direction and the second direction is in a predetermined range including 180 degrees.

15. The information processing system according to claim 14, the processor being further configured to:
individually for the at least one sound source, determine the volume reference position to be at the position of the virtual microphone by setting the degree to be minimized in a case where the angle between the first direction and the second direction is in a predetermined range including 0 degrees.

16. The information processing system according to claim 9, the processor being further configured to:
control a player character in the virtual space on the basis of the operation input; and
determine the position of the look-at point so as to follow a position of the player character.

17. An information processing apparatus comprising a processor, the processor being configured to:
determine a position of a look-at point of a virtual camera in a virtual space on the basis of an operation input;
control a viewing direction of the virtual camera on the basis of the operation input;
determine a position of the virtual camera on the basis of the position of the look-at point and the viewing direction;
determine a position of a virtual microphone in the virtual space, to be a position interlocked with the position of the virtual camera; and
individually for at least one sound source placed in the virtual space,
determine a volume for outputting a sound set for the sound source, on the basis of a distance between the sound source and a volume reference position which is set at the position of the virtual microphone or which is set at a position shifted toward the look-at point side from the position of the virtual microphone in a case where the sound source is placed on a side opposite to the look-at point with respect to the virtual microphone, and
output the sound set for the sound source on the basis of the determined volume.

18. The information processing apparatus according to claim 17, the processor being further configured to:
individually for the at least one sound source,
determine localization of the sound set for the sound source, on the basis of a positional relationship between the virtual microphone and the sound source in the virtual space; and
output the sound set for the sound source, on the basis of the determined localization and the determined volume.

19. The information processing apparatus according to claim 18, the processor being further configured to:
individually for the at least one sound source, determine the volume reference position to be any position on a line from the position of the virtual camera or the position of the virtual microphone to the position of the look-at point.

20. The information processing apparatus according to claim 19, the processor being further configured to:
individually for the at least one sound source, determine the volume reference position for the sound source to be a position that becomes closer to the look-at point on the line as the position of the sound source becomes closer to a direction opposite to a direction toward the look-at point with respect to the position of the virtual microphone.

21. The information processing apparatus according to claim 20, the processor being further configured to:
individually for the at least one sound source,
determine a degree in which the position of the sound source is close to the direction opposite to the direction toward the look-at point with respect to the position of the virtual microphone, on the basis of a difference between a first direction from the position of the virtual camera or the virtual microphone to the look-at point and a second direction from said position to the sound source, and
determine the volume reference position for the sound source to be a position that becomes closer to the look-at point on the line as the degree becomes higher.

22. The information processing apparatus according to claim 21, the processor being further configured to:
individually for the at least one sound source, determine the volume reference position to be at the position of the look-at point by setting the degree to be maximized in a case where an angle between the first direction and the second direction is in a predetermined range including 180 degrees.

23. The information processing apparatus according to claim 22, the processor being further configured to:
individually for the at least one sound source, determine the volume reference position to be at the position of the virtual microphone by setting the degree to be minimized in a case where the angle between the first direction and the second direction is in a predetermined range including 0 degrees.

24. The information processing apparatus according to claim 17, the processor being further configured to:
control a player character in the virtual space on the basis of the operation input; and
determine the position of the look-at point so as to follow a position of the player character.

25. A sound processing method to be executed by a computer for controlling an information processing apparatus, the method causing the computer to:
determine a position of a look-at point of a virtual camera in a virtual space on the basis of an operation input;
control a viewing direction of the virtual camera on the basis of the operation input;
determine a position of the virtual camera on the basis of the position of the look-at point and the viewing direction;
determine a position of a virtual microphone in the virtual space, to be a position interlocked with the position of the virtual camera; and
individually for at least one sound source placed in the virtual space,
determine a volume for outputting a sound set for the sound source, on the basis of a distance between the sound source and a volume reference position which is set at the position of the virtual microphone or which is set at a position shifted toward the look-at point side from the position of the virtual microphone in a case where the sound source is placed on a side opposite to the look-at point with respect to the virtual microphone, and
output the sound set for the sound source on the basis of the determined volume.

26. The sound processing method according to claim 25, further causing the computer to:
individually for the at least one sound source,
determine localization of the sound set for the sound source, on the basis of a positional relationship between the virtual microphone and the sound source in the virtual space; and
output the sound set for the sound source, on the basis of the determined localization and the determined volume.

27. The sound processing method according to claim 26, further causing the computer to:
individually for the at least one sound source, determine the volume reference position to be any position on a line from the position of the virtual camera or the position of the virtual microphone to the position of the look-at point.

28. The sound processing method according to claim 27, further causing the computer to:
individually for the at least one sound source, determine the volume reference position for the sound source to be a position that becomes closer to the look-at point on the line as the position of the sound source becomes closer to a direction opposite to a direction toward the look-at point with respect to the position of the virtual microphone.

29. The sound processing method according to claim 28, further causing the computer to:
individually for the at least one sound source,
determine a degree in which the position of the sound source is close to the direction opposite to the direction toward the look-at point with respect to the position of the virtual microphone, on the basis of a difference between a first direction from the position of the virtual camera or the virtual microphone to the look-at point and a second direction from said position to the sound source, and
determine the volume reference position for the sound source to be a position that becomes closer to the look-at point on the line as the degree becomes higher.

30. The sound processing method according to claim 29, further causing the computer to:
individually for the at least one sound source, determine the volume reference position to be at the position of the look-at point by setting the degree to be maximized in a case where an angle between the first direction and the second direction is in a predetermined range including 180 degrees.

31. The sound processing method according to claim 30, further causing the computer to:
individually for the at least one sound source, determine the volume reference position to be at the position of the virtual microphone by setting the degree to be minimized in a case where the angle between the first direction and the second direction is in a predetermined range including 0 degrees.

32. The sound processing method according to claim 25, further causing the computer to:
control a player character in the virtual space on the basis of the operation input; and
determine the position of the look-at point so as to follow a position of the player character.
